(19) United States
(12) Patent Application Publication
(10) Pub. No.: US 2004/0014824 A1
(43) Pub. Date: Jan. 22, 2004

(54) Alkyl phenolglyoxal resins and their use as demistifiers

(76) Inventors: Dirk Leinweber, Burghausen (DE); Elisabeth Wasmund, Burgkirchen (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/432,002

(22) PCT Filed: Oct. 31, 2001
(86) PCT No.: PCT/EP01/12629

(30) Foreign Application Priority Data
Nov. 17, 2000 (DE) 10057043.7

(51) Int. Cl. C09K 3/00

(52) U.S. Cl. 516/183

(57) ABSTRACT

The invention relates to resins that can be obtained from compounds of formula (1), in which substituents R¹ and OH can, with regard to one another, be located in ortho position, meta position or para position, and R¹ represents C₁-C₃₀ alkyl, C₂-C₃₀ alkenyl, C₆-C₁₈ aryl or C₇₋₃₀ alkyl aryl. The inventive resins are produced using the following steps, which can be carried out in any order: A) reacting with glyoxal; and B) alkoxylating with a C₂-C₄ alkylene oxide in molar excess so that the resulting alkoxyllate has a degree of alkoxylation of 1 to 100 alkylene oxide units per OH group. In addition, the inventive resins have a molecular weight ranging from 250 to 100,000 units. The invention also relates to the use of these resins as demulsifiers for oil-in-water emulsions, in particular, in the domain of petroleum extraction.

The present invention relates to the use of resins preparable by condensation of alkylphenols with glyoxal for breaking water-oil emulsions, in particular in the production of crude oil.

During its recovery, crude oil is produced as an emulsion with water. Before the crude oil is further processed, these crude oil emulsions must be broken into the oil and water constituents. For this purpose, use is generally made of petroleum breakers. Petroleum breakers are surface-active compounds which are able to effect the required separation of the emulsion constituents within a short time.

The petroleum breakers used are, inter alia, alkylphenol aldehyde resins, which are disclosed, for example, in U.S. Pat. No. 4,032,514. These resins are obtainable from the condensation of a p-alkylphenol with an aldehyde, in most cases formaldehyde. The resins are often used in alkoxylated form, as is disclosed, for example, in DE-A-24 45 873. For this, the free phenolic OH groups are reacted with an alkylene oxide.

The preparation of alkylphenol glyoxal condensates has been described in U.S. Pat. No. 4,816,498. The resins prepared therein, however, were neither alkoxylated nor used as petroleum breakers.

U.S. Pat. No. 2,499,370 discloses alkoxylated alkylphenol glyoxal resins and their use as petroleum demulsifiers. However, the document expressly shows that glyoxal participates only with one of its carbonyl groups in the condensation of the alkylphenols. This simple condensation is referred to as significant for the desired success.

The varying properties (e.g. asphaltene and paraffin content) and proportions of water in different crude oils make it imperative to further develop the existing petroleum demulsifiers. In particular, a low dosing rate of the demulsifier to be used as well as the higher effectiveness which is to be strived for is most important from an economic and ecological point of view.

The object was thus to develop novel petroleum breakers which are superior in their effect to the alkylphenol aldehyde resins already known, and can be used in an even lower concentration.

Surprisingly, it has been found that resins based on alkylphenol glyoxal condensates exhibit an excellent effect as petroleum breakers even at a very low concentration.

The invention therefore provides resins obtainable from compounds of the formula (1)

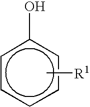

in which the substituents R¹ and OH may be in the ortho, meta or para position relative to one another, and R¹ is C₁-C₃₀-alkyl, C2-C₃₀-alkenyl, C₆-C₁₃-aryl or C₇-C₃₀-alkylaryl, by the following steps, which can be carried out in any order,

A) reaction with glyoxal and

B) alkoxylation with a C₂-C₄-alkylene oxide in molar excess, such that the resulting alkoxylate has a degree of alkoxylation of from 1 to 100 alkylene oxide units per OH group,

and which have a molecular weight of from 250 to 100 000 units.

The compounds of the formula (1) are essentially chemically uniform compounds which are not used in mixtures with one another. The term “essentially” here means that compounds of the formula (1) in standard commercial purity are used for the preparation of the resins according to the invention. Fractions of further compounds which come under the formula (1) may also be present in the resins; reference may be made, in particular, to fractions of each of the two other aromatic substitutional isomers which have not been completely separated off. The glyoxal too is essentially to be used as a uniform substance, a glyoxal of standard commercial purity being used.

If the radical R¹ is an alkenyl or alkyl radical, then its chain length is preferably 2 to 24, particularly preferably 4 to 22, specifically 4 to 18, carbon atoms. Alkyl and alkenyl radicals may either be linear or branched.

If the radical R¹ is an alkylaryl radical, then alkylaryl is preferably a radical bonded via an aromatic nucleus, whose aromatic nucleus preferably comprises six carbon atoms, and which, in the ortha, meta or para position relative to the abovementioned bond, carries an alkyl radical having a chain length of preferably 1 to 18, particularly preferably 4 to 16, in particular 6 to 12, carbon atoms.

If step A is firstly carried out followed by step B, then the compounds of the formula (1) are reacted with glyoxal to give a resin. The condensation can either be carried out with acidic or basic catalysis. The resins obtained from the condensation are then alkoxylated with a C₂-C₄-alkylene oxide, preferably ethylene oxide or propylene oxide. The alkoxylating agent is used in a molar excess. The alkoxylation takes place on the free OH groups of the resulting resin. The amount of alkylene oxide used is such that the average degree of alkoxylation is between 1 and 100 alkylene oxide units per free OH group. The average degree of alkoxylation is understood here as meaning the average number of alkoxy units which are positioned on each free OH group. It is preferably 1 to 70, in particular 2 to 50.

The resin obtained following condensation and alkoxylation preferably has a molecular weight from 500 to 50 000 units, in particular from 1 000 to 10 000 units.

The resins according to the invention are, in particular, characterized in that the glyoxal in them is bonded to the alkylphenol radicals with its two aldehyde functions. The condensation of the two aldehyde functions leads to polynuclear alkylphenol glyoxal resins with high molecular weights. It is possible to prepare resins with degrees of condensation of preferably 16 and more, in particular 18 and more, alkylphenol groups.

Preferred resins obtainable by the described process have, for example, the following structures:

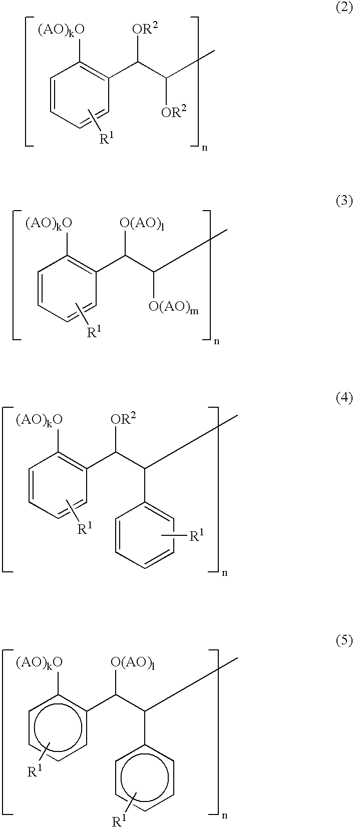

(AO)_{k,l,m}O is the alkoxylated OH radical in which AO is the alkylene oxide unit, and k, l and m are the degrees of alkoxylation. The bridging of the aromatic rings via the carbon atom carrying the radical R² can be located on any of the free positions of the aromatic rings. n is the degree of condensation of the resin. n is preferably a number from 2 to about 100, in particular 3 to 50, particularly preferably 4 to 30, specifically 4 to 10.

If glyoxal is used for the condensation, then the radical R² is initially hydrogen. The free OH group which forms can, however, be esterified or etherified prior to the oxyalkylation, meaning that, as well as hydrogen, R² can also assume the meaning C₁-C₃₀-alkyl-CO—, C₂-C₃₀-alkenyl-CO—, C₆-C₁₈-aryl-CO— or C₇-C₃₀-alkylaryl-CO— or C₁-C₃₀-alkyl, C₂-C₃₀-alkenyl, C₆-C₁₈-aryl or C₇-C₃₀-alkylaryl. These compounds are likewise suitable for the use according to the invention.

The present invention further provides for the use of the resins according to the invention as breakers for oil/water emulsions, in particular in petroleum recovery.

For use as petroleum breakers, the resins are added to the water-oil emulsions, which preferably takes place in solution. Preferred solvents for the resins are paraffinic or aromatic solvents. The resins are used in amounts of from 0.0001 to 5% by weight, preferably 0.0005 to 2% by weight, in particular 0.0008 to 1% by weight and specifically 0.001 to 0.1% by weight, of resin, based on the oil content of the emulsion to be broken.

The resins according to the invention are generally prepared by acid- or alkali-catalyzed condensation of the corresponding alkylphenols with glyoxal, where the alkoxylation can precede or follow the condensation. The reaction temperature is generally between 50 and 170° C., preferably 120 to 165° C. The reaction is normally carried out at atmospheric pressure. Examples of catalyzing acids are HCl, H₂SO₄, sulfonic acids or H₃PO₄, and bases which may be mentioned are NaOH, KOH or triethylamine, which are used in amounts of from 0.1 to 50% by weight, based on the weight of the reaction mixture. The condensation generally requires from 30 min to 6 hours. The molar ratio between aldehyde and aromatic compound is generally from 0.5:1 to 4:1, preferably from 0.8:1 to 1.8:1.

As is known from the prior art, the alkoxylation takes place by reacting the resins with an alkylene oxide under an increased pressure of generally from 1.1 to 20 bar at temperatures of from 50 to 200° C.

### EXAMPLES

### Example 1

### Reaction of p-tert-Butylphenol With Glyoxal (Acidic Catalysis)

100.0 g of p-tert-butylphenol (M=150), 100 ml of an aromatic solvent and 1.1 g of alkylbenzenesulfonic acid (0.5 mol %) were introduced into a 500 ml four-necked flask fitted with contact thermometer, stirrer, dropping funnel and water separator. With stirring and nitrogen blanketing, the reaction mixture was heated to 120° C. and, at this temperature, 19.3 g of aqueous glyoxal solution (50% strength) were slowly added dropwise. When the addition was complete, the mixture was stirred for one hour at 120° C. and for one hour at 165° C., and the water of reaction which formed was withdrawn via the separator. The product was evaporated to dryness on a rotary evaporator (yield: 108.3 g) and analyzed by GPC.

### Example 2

### Reaction of p-tert-Butylphenol With Glyoxal (Alkaline Catalysis)

100.0 g of p-tert-butylphenol (M=150), 100 g of an aromatic solvent and 1.6 g of 40% strength potassium hydroxide solution were introduced into a 500 ml four-necked flask fitted with contact thermometer, stirrer, dropping funnel and water separator. With stirring and nitrogen blanketing, the reaction mixture was heated to 120° C. and, at this temperature, 19.3 g of aqueous glyoxal solution (50% strength) were slowly metered in. When the addition was complete, the mixture was stirred for one hour at 120° C. and for a further hour at 165° C., and the water of reaction which formed was withdrawn via the separator. The product was evaporated to dryness on a rotary evaporator (yield: 104.0 g) and analyzed by means of GPC.

### Example 3

### Reaction of p-Cumylphenol With Glyoxal (Acidic Catalysis)

100.0 g of p-cumylphenol (M=212), 100 ml of an aromatic solvent and 0.8 g of alkylbenzenesulfonic acid (0.5 mol %) were introduced into a 500 ml four-necked flask fitted with contact thermometer, stirrer, dropping funnel and water separator. With stirring and nitrogen blanketing, the reaction mixture was heated to 120° C. and, at this temperature, 13.6 g of aqueous glyoxal solution (50% strength) were slowly added dropwise. When the addition was complete, the mixture was stirred for one hour at 120° C. and for one hour at 165° C., and the water of reaction which formed was withdrawn via the separator. The product was evaporated to dryness on a rotary evaporator (yield: 104.9 g) and analyzed by means of GPC.

### Example 4

### Reaction of Cardanol With Glyoxal (Acidic Catalysis)

100.0 g of cardanol (m=C₁₅-alkenylphenol, M=302), 100 ml of an aromatic solvent and 0.5 g of alkylbenzenesulfonic acid (0.5 mol %) were introduced into a 500 ml four-necked flask fitted with contact thermometer, stirrer, dropping funnel and water separator. With stirring and nitrogen blanketing, the reaction mixture was heated to 120° C. and, at this temperature, 9.6 g of aqueous glyoxal solution (50% strength) were slowly added dropwise. When the addition was complete, the mixture was stirred for one hour at 120° C. and for one hour at 165° C., and the water of reaction which formed was withdrawn via the separator. The product was evaporated to dryness on a rotary evaporator (yield: 102.8 g) and analyzed by means of GPC.

### Example 5

### Reaction of p-Isononylphenol With Glyoxal (Acidic Catalysis)

100.0 g of p-isononylphenol (M=220), 100 ml of an aromatic solvent and 0.8 g of alkylbenzenesulfonic acid (0.5 mol %) were introduced into a 500 ml four-necked flask fitted with contact thermometer, stirrer, dropping funnel and water separator. With stirring and nitrogen blanketing, the reaction mixture was heated to 120° C. and, at this temperature, 14.5 g of aqueous glyoxal solution (50% strength) were slowly added dropwise. When the addition was complete, the mixture was stirred for one hour at 120° C. and for one hour at 165° C., and the water of reaction which formed was withdrawn via the separator. The product was evaporated to dryness on a rotary evaporator (yield: 105.1 g) and analyzed by means of GPC.

### Example 6

### Reaction of p-Phenylphenol With Glyoxal (Acidic Catalysis)

100.0 g of p-phenylphenol (M=170), 100 ml of an aromatic solvent and 1.0 g of alkylbenzenesulfonic acid (0.5 mol %) were introduced into a 500 ml four-necked flask fitted with contact thermometer, stirrer, dropping funnel and water separator. With stirring and nitrogen blanketing, the reaction mixture was heated to 120° C. and, at this temperature, 17.0 g of aqueous glyoxal solution (50% strength) were slowly added dropwise. When the addition was complete, the mixture was stirred for one hour at 120° C. and for one hour at 165° C., and the water of reaction which formed was withdrawn via the separator. The product was evaporated to dryness on a rotary evaporator (yield: 107.4 g) and analyzed by means of GPC.

### Example 7

### Reaction of p-tert-Butylphenol and p-Isononylphenol With Glyoxal (Acidic Catalysis)

50.0 g of p-tert-butylphenol (M=150), 50 g of p-nonylphenol (M=220), 100 ml of an aromatic solvent and 0.9 g of alkylbenzenesulfonic acid (0.5 mol %) were introduced into a 500 ml four-necked flask fitted with contact thermometer, stirrer, dropping funnel and water separator. With stirring and nitrogen blanketing, the reaction mixture was heated to 120° C. and, at this temperature, 15.6 g of aqueous glyoxal solution (50% strength) were slowly added dropwise. After the addition was complete, the mixture was stirred for one hour at 120° C. and for one hour at 165° C., and the water of reaction which formed was withdrawn via the separator. The product was evaporated to dryness on a rotary evaporator (yield: 105.6 g) and analyzed by means of GPC.

### Example 8

### Reaction of p-tert-Butylphenol With Glyoxal (Acidic Catalysis) and Subsequent Esterification With Dodecanoic Acid

100.0 g of p-tert-butylphenol (M=150), 100 ml of an aromatic solvent and 1.1 g of alkylbenzenesulfonic acid (0.5 mol %) were introduced into a 1000 ml four-necked flask fitted with contact thermometer, stirrer, dropping funnel and water separator. With stirring and nitrogen blanketing, the reaction mixture was heated to 120° C. and, at this temperature, 19.3 g of aqueous glyoxal solution (50% strength) were slowly added dropwise. When the addition was complete, the mixture was stirred for one hour at 120° C. and for one hour at 165° C., and the water of reaction which formed was withdrawn via the separator. The reaction mixture was cooled to 120° C., 270 9 (M=200) of dodecanoic acid in 200 g of an aromatic solvent were added dropwise, and the water of reaction which formed was withdrawn via the separator. The product was evaporated to dryness on a rotary evaporator (yield: 365.3 g) and analyzed by means of GPC.

### Oxyalkylation of the Alkylphenol Glyoxal Condensates

Ethylene Oxide

The resins described above were introduced into a 1 I glass autoclave and the pressure in the autoclave was adjusted to about 0.2 bar above atmospheric with nitrogen. The autoclave was heated slowly to 140° C. and, after this temperature had been reached, the pressure was adjusted again to 0.2 bar above atmospheric. Then, at 140° C., the desired amount of EO was metered in, during which the pressure should not exceed 4.5 bar. When the EO addition was complete, the mixture was left to after-react for a further 30 minutes at 140° C.

Propylene Oxide

The resins described above were introduced into a 1 l glass autoclave and the pressure in the autoclave was adjusted to about 0.2 bar above atmospheric with nitrogen. The autoclave was slowly heated to 130° C. and, after this temperature had been reached, the pressure was again adjusted to 0.2 bar above atmospheric. Then, at 130° C., the desired amount of PO was metered in, during which the pressure should not exceed 4.0 bar. When the PO addition was complete, the mixture was left to after-react for a further 30 minutes at 130° C.

### Determination of the Breaking Effectiveness of Petroleum Demulsifiers

To determine the effectiveness of a demulsifier, the water separation from a crude oil emulsion per time, and also the dewatering and desalting of the oil were determined. For this, demulsifying glasses (tapered, graduated glass bottles with screw lids) were charged in each case with 100 ml of the crude oil emulsion, in each case a defined amount of the demulsifier was metered in just below the surface of the oil emulsion using a micropipette, and the breaker was mixed into the emulsion by intensive shaking. The demulsifying glasses were then placed in a conditioning bath (30° C. and 50° C.) and water separation was monitored.

During demulsification and after it had finished, samples were taken from the oil from the upper section of the demulsifying glass (so-called top oil), and the water content was determined in accordance with Karl Fischer and the salt content was determined conductometrically. In this way, it was possible to assess the novel breakers according to water separation and also dewatering and desalting of the oil.

### Breaking Action of the Breakers Described

Origin of the crude oil emulsion: Holzkirchen sonde 3, Germany

Water content of the emulsion: 46%

Salt content of the emulsion: 5%

Demulsification temperature: 500° C.

| Water | | | | | | | | | | | Water | Salt in |
|---|---|---|---|---|---|---|---|---|---|---|---|---|
| separation | Concen- | | | | | | | | | | in the | the |
| [ml ]per time | tration | | | | | | | | | | top oil | top oil |
| [min ] | [ppm] | 5 | 10 | 20 | 30 | 45 | 60 | 90 | 120 | 180 | [%] | [ppm] |
| Product | 50 | 2 | 10 | 19 | 33 | 41 | 45 | 46 | 46 | 46 | 0.32 | 75 |
| from 1 + 4.2 | | | | | | | | | | | | |
| mol of EO | | | | | | | | | | | | |
| Product | 50 | 3 | 11 | 23 | 38 | 44 | 46 | 46 | 46 | 46 | 0.24 | 51 |
| from 2 + 5.0 | | | | | | | | | | | | |
| mol of EO | | | | | | | | | | | | |
| Product | 50 | 1 | 7 | 13 | 19 | 28 | 40 | 45 | 46 | 46 | 0.69 | 95 |
| from 3 + 3.6 | | | | | | | | | | | | |
| mol of EO | | | | | | | | | | | | |
| Product | 50 | 3 | 9 | 19 | 32 | 40 | 45 | 46 | 46 | 46 | 0.41 | 81 |
| from 4 + 6.2 | | | | | | | | | | | | |
| mol of EO | | | | | | | | | | | | |
| Product | 50 | 2 | 8 | 16 | 30 | 39 | 44 | 45 | 45 | 46 | 0.38 | 71 |
| from 5 + 8.2 | | | | | | | | | | | | |
| mol of EO | | | | | | | | | | | | |
| Product | 50 | 2 | 7 | 15 | 20 | 29 | 36 | 42 | 44 | 45 | 1.15 | 104 |
| from 6 + 30.3 | | | | | | | | | | | | |
| mol of PO | | | | | | | | | | | | |
| Product | 50 | 2 | 9 | 17 | 22 | 31 | 39 | 43 | 43 | 45 | 0.97 | 110 |
| from 7 + 20.4 | | | | | | | | | | | | |
| mol of PO | | | | | | | | | | | | |
| Product | 50 | 1 | 5 | 12 | 20 | 29 | 38 | 42 | 43 | 44 | 1.02 | 96 |
| from 8 + 19.8 | | | | | | | | | | | | |
| mol of PO | | | | | | | | | | | | |
| Standard: | 100 | 0 | 4 | 10 | 17 | 26 | 34 | 39 | 42 | 43 | 1.58 | 198 |
| Dissolvan | | | | | | | | | | | | |
| 1952 | | | | | | | | | | | | |

1. A resin obtainable from compounds of the formula (1) 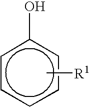
in which the substituents R¹ and OH may be in the ortho, meta or para position relative to one another, and R¹ is C₁-C₃₀-alkyl, C₂-C₃₀-alkenyl, C₆-C₁₈-aryl or C₇-C₃₀-alkylaryl, by the following steps, which can be carried out in any order,
A) reaction with glyoxal and
B) alkoxylation with a C₂-C₄-alkylene oxide in molar excess, such that the resulting alkoxylate has a degree of alkoxylation of from 1 to 100 alkylene oxide units per OH group,
and which has a molecular weight of from 250 to 100 000 units, wherein said resins contain structures of the formulae 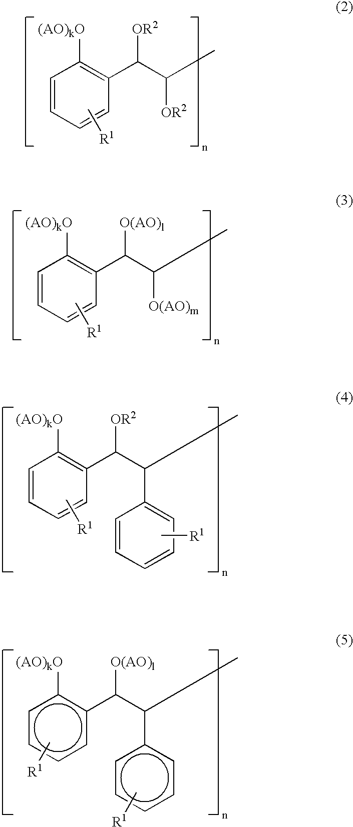
in which the degrees of partial alkoxylation k, l and m produce in total the degree of alkoxylation from 1 to 100, A is a C₂-C₄-alkylene group, n is a number from 2 to 100 and R² is hydrogen, C₁-C₃₀-alkyl-CO—, C₂-C₃₀-alkenyl-CO—, C₆-C₁₈-aryl-CO—, C₇-C₃₀-alkylaryl-CO—, C₁-C₃₀-alkyl, C₂-C₃₀-alkenyl, C₆-C₁₈-aryl or C₇-C₃₀-alkylaryl.

2. The resin as claimed in claim 1, in which R¹ is an alkyl or alkenyl radical having 4 to 12 carbon atoms.

3. The resin as claimed in claim 1 and/or 2, in which the degree of alkoxylation is between 2 and 50.

4. The resin as claimed in one or more of claims 1 to 3, in which the molecular weight is between 1000 and 10 000.

5. The use of the resins as claimed in one or more of claims 1 to 4 in amounts of from 0.0001 to 5% by weight, based on the emulsion, as breaker for oil/water emulsions, in particular in petroleum recovery.
